(19) United States
(12) Patent Application Publication
(10) Pub. No.: US 2015/0140367 A1
(43) Pub. Date: May 21, 2015

(54) BATTERY MODULE

(71) Applicant: KABUSHIKI KAISHA TOSHIBA, Tokyo (JP)

(72) Inventors: Ryosuke YAGI, Yokohama (JP); Mitsunobu Yoshida, Kawasaki (JP); Tomonao Takamatsu, Kawasaki (JP); Nobukatsu Sugiyama, Kawasaki (JP); Norihiro Tomimatsu, Tokyo (JP)

(21) Appl. No.: 14/504,484

(22) Filed: Oct. 2, 2014

(30) Foreign Application Priority Data
Nov. 20, 2013 (JP) 2013-240450

(51) Int. Cl. H01M 10/6551; H01M 2/20

(52) U.S. Cl. CPC H01M 10/5046; H01M 2/204; H01M 2/206
USPC 429/50; 429/120

(57) ABSTRACT

According to one embodiment, a battery module includes, battery cells including an electrode group including an anode, a cathode, and a separator interposed between the anode and the cathode, a terminal electrically connected to the electrode group, and a packaging member which contains the electrode group and through which the terminal is extracted outside from inside a container portion, a bus bar configured to electrically connect the terminals of the battery cells, a heat storage unit containing a latent heat storage material, and an electric insulating sheet configured to thermally connect the bus bar and the heat storage unit.

### CROSS-REFERENCE TO RELATED APPLICATION

This application is based upon and claims the benefit of priority from prior Japanese Patent Application No. 2013-240450, filed Nov. 20, 2013, the entire contents of which are incorporated herein by reference.

### FIELD

Embodiments described herein relate generally to a battery module including a cooling structure.

### BACKGROUND

There is a battery which maintains a low temperature by absorbing heat to a heat storage material in order to improve the reliability. In this battery, a corrugate portion processed into a projection-and-recess shape is formed as a heat radiating member around the circumferential surface of the battery. Heat generated from the battery is radiated outside via the corrugate portion.

Heat generation by a battery when it is charged is proportional to the square of a current value, and deterioration progresses at high temperatures depending on a material forming the battery. Therefore, heat generation by a battery when it is charged, particularly, heat generation by a battery when it is rapidly charged is a serious problem. Accordingly, maintaining the temperature of a battery within an appropriate range by improving the heat radiation properties of the battery is an important factor in improving the reliability and durability of the battery.

### BRIEF DESCRIPTION OF THE DRAWINGS

FIG. 1 is a schematic view showing the overall arrangement of a battery pack of the first embodiment;

FIG. 2 is a perspective view showing the interior of a battery module included in the battery pack shown in FIG. 1;

FIG. 3 is a sectional view taken along a line F3-F3 of the battery module shown in FIG. 2;

FIG. 4 is a conceptual view showing the relationship between the temperature of battery cells (first to third battery cells) shown in FIG. 3 and the temperature of a heat storage material when the battery cells are charged or discharged;

FIG. 5 is a conceptual view showing the relationship between the temperature of the battery cells (first to third battery cells) shown in FIG. 3 and the temperature of the heat storage material when the charging or discharging of the battery cells is stopped;

FIG. 6 is a sectional view of a battery module included in a battery pack of the second embodiment;

FIG. 7 is a table showing the measurement results of an example of battery cells in the battery module of the second embodiment;

FIG. 8 is a sectional view of a battery module included in a battery pack of the third embodiment; and

FIG. 9 is a sectional view of a battery module included in a battery pack of the fourth embodiment.

### DETAILED DESCRIPTION

According to one embodiment, a battery module includes, a battery cell including an electrode group including an anode, a cathode, and a separator interposed between the anode and the cathode, a terminal electrically connected to the electrode group, and a packaging member which contains the electrode group and through which the terminal is extracted outside from inside a container portion, a bus bar including a plurality of battery cells and configured to electrically connect the terminals of the battery cells, a heat storage unit containing a latent heat storage material, and an electric insulating sheet configured to thermally connect the bus bar and the heat storage unit.

### First Embodiment

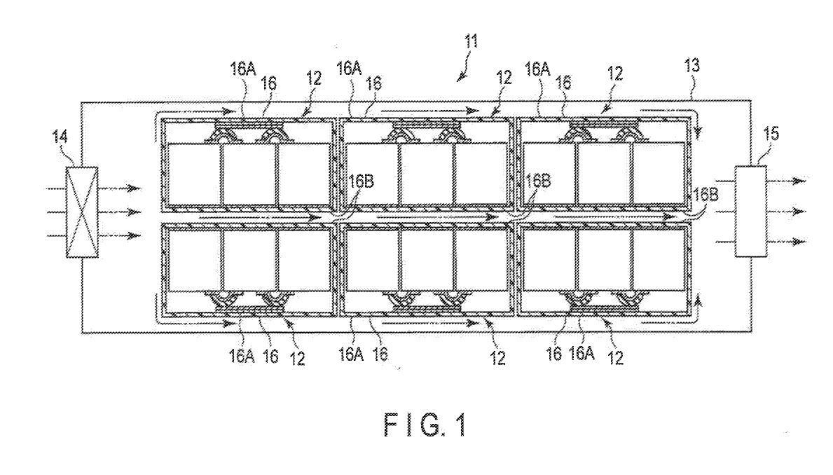

The first embodiment of a battery pack will be explained below with reference to FIGS. 1, 2, 3, 4, and 5.

As shown in FIG. 1, a battery pack 11 contains a battery module 12 inside the pack, and can secure an arbitrary battery capacity by accommodating a plurality of battery modules in accordance with an application.

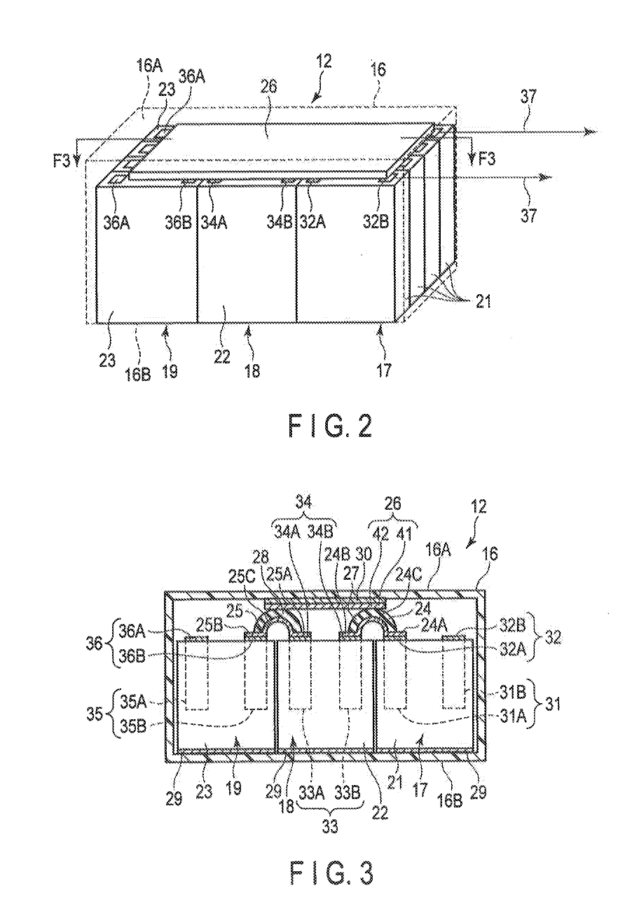

As shown in FIGS. 1 and 2, the battery pack 11 includes a case 13 forming the outer shell, a plurality of battery modules 12 contained in the case 13, an air supply unit 14 (a fan unit) which supplies cooling air into the case 13 by a built-in fan, and an exhaust unit 15 (exhaust holes). The battery modules 12 included in the battery pack 11 have the same structure.

As shown in FIGS. 2 and 3, each battery module 12 includes a housing 16, and first, second, and third battery cell groups 17, 18, and 19 accommodated inside the housing 16. The first battery cell group 17 includes a plurality of first battery cells 21 (as an example, four first battery cells 21). The second battery cell group 18 includes a plurality of second battery cells 22 (as an example, four second battery cells 22). The third battery cell group 19 includes a plurality of third battery cells 23 (as an example, four third battery cells 23).

As shown in FIG. 3, each battery module 12 includes a plurality of first bus bars 24 (as an example, four first bus bars 24) for electrically connecting a first positive terminal 32A of the first battery cell 21 and a second negative terminal 34B of the second battery cell 22, a plurality of second bus bars 25 (as an example, four second bus bars 25) for electrically connecting a second positive terminal 34A of the second battery cell 22 and a third negative terminal 36B of the third battery cell 23, a heat storage unit 26 adhered to one inner surface 16A of the housing 16 by a sheet-like adhesive portion 30, a plurality of first electric insulating sheets 27 (as an example, four first electric insulating sheets 27) formed to cover the first bus bars 24 and interposed between the heat storage unit 26 and first bus bars 24, a plurality of second electric insulating sheets 28 (as an example, four second electric insulating sheets 28) formed to cover the second bus bars 25 and interposed between the heat storage unit 26 and second bus bars 25, and an adhesive 29 for fixing the first, second, and third battery cells 21, 22, and 23 to the housing 16.

Each first battery cell 21 is a secondary battery which can repetitively be charged and discharged. The first battery cell 21 accommodates, inside a packaging member made of a metal case such as an aluminum case, an electrode group formed by winding or stacking a cathode (cathode electrode) and anode (anode electrode) and a separator interposed between the cathode and anode, and also accommodates an electrolyte. The first battery cell 21 may also be formed by using, as a packaging member, a laminated film including a resin layer and an aluminum layer overlaid on the resin layer, instead of the metal case. The first battery cell 21 includes a pair of first electrodes 31 and a pair of first terminals 32. The pair of first electrodes 31 include a first cathode 31A and first anode 31B. The pair of first terminals 32 include the first positive terminal 32A electrically connected to the first cathode 31A, and a first negative terminal 32B electrically connected to the first anode 31B. The first positive terminal 32A and first negative terminal 32B are extracted outside from inside the accommodating portion of the packaging member.

Each second battery cell 22 and each third battery cell 23 have the same structure as that of the first battery cell 21. The second battery cell 22 includes a pair of second electrodes 33 and a pair of second terminals 34. The pair of second electrodes 33 include a second cathode 33A and second anode 33B. The pair of second terminals 34 include the second positive terminal 34A electrically connected to the second cathode 33A, and the second negative terminal 34B electrically connected to the second anode 33B.

The third battery cell 23 includes a pair of third electrodes 35 and a pair of third terminals 36. The pair of third electrodes 35 include a third cathode 35A and third anode 35B. The pair of third terminals 36 include a third positive terminal 36A electrically connected to the third cathode 35A, and the third negative terminal 36B electrically connected to the third anode 35B. Of the plurality of battery cells (the first to third battery cells 21 to 23) connected by the first bus bars 24 and second bus bars 25, the terminal of a battery cell positioned at the end is connected to a load cable 37 outside the battery module 12, and gives a load to a target driving apparatus (see FIG. 2).

As shown in FIG. 3, each first bus bar 24 includes an end portion 24A fixed to the first positive terminal 32A of the first battery cell 21 by a screw or the like, an end portion 24B fixed to the second negative terminal 34B of the second battery cell 22 by a screw or the like, and a first arched portion 24C formed between the end portions 24A and 24B. The first bus bar 24 physically fixes the first and second battery cells 21 and 22. The first bus bar 24 is formed by a conductive metal material. The first bus bar 24 is made of, e.g., aluminum, but the material of the first bus bar 24 is not limited to aluminum, and may also be, e.g., copper.

Each second bus bar 25 includes a first end portion 25A fixed to the second positive terminal 34A of the second battery cell 22 by a screw or the like, a second end portion 25B fixed to the third negative terminal 36B of the third battery cell 23 by a screw or the like, and a second arched portion 25C formed between the end portions 25A and 25B. The second bus bar 25 physically fixes the second and third battery cells 22 and 23. The second bus bar 25 is formed by a conductive metal material. The second bus bar 25 is made of, e.g., aluminum, but the material of the second bus bar 25 is not limited to aluminum, and may also be a metal material having a high thermal conductivity such as copper.

The heat storage unit 26 includes a square box-like container case 41, and a heat storage material 42 contained in the container case 41. A surface of the container case 41, which is opposite to a surface opposing the first and second bus bars 24 and 25, is in contact with the housing 16 with the adhesive portion 30 intervening between them. The adhesive portion 30 is not limited to adhesion as long as the container case 41 is fixed to the housing 16. The container case 41 is formed by a metal material such as aluminum. The material of the container case 41 is not limited to aluminum, and may also be another metal material such as stainless steel, or a resin material such as a polyphenylene sulfide (PPS) resin or polyethylene (PE) resin.

The heat storage material 42 is a latent heat storage material made of a phase change material which absorbs heat when changing from a solid to a liquid, and radiates (generates) heat when changing from a liquid to a solid. In this embodiment, the heat storage material 42 is, e.g., a sodium acetate hydrate-based latent heat storage material. Note that the heat storage material 42 is not limited to the sodium acetate hydrate-based latent heat storage material, and it is also possible to use a paraffin-based or sodium sulfate hydrate-based latent heat storage material. The melting point of the heat storage material 42 is set at an arbitrary temperature which is higher than room temperature and lower than the highest operation temperature of the battery cells (first to third battery cells 21 to 23). More specifically, the melting point of the heat storage material 42 is set at an appropriate value within the range of 40° C. to 60° C.

The first electric insulating sheet 27 is formed by a rubber-like elastic (flexible) sheet. The first electric insulating sheet 27 is installed as it is pressed between the heat storage unit 26 and the first arched portion 24C of the first bus bar 24. The first electric insulating sheet 27 thermally connects the first bus bar 24 and heat storage unit 26. The first electric insulating sheet 27 has electric insulation which withstands the voltage of each battery cell. More specifically, the first electric insulating sheet 27 has a dielectric breakdown strength of 1 kV/mm or more as a dielectric breakdown strength complying with JIS-C2110. The first electric insulating sheet 27 is formed by, e.g., a rubber sheet, but the material of the first electric insulating sheet 27 is not limited to this. The first electric insulating sheet 27 may also be a low-hardness acrylic sheet or foamed sheet. The first electric insulating sheet 27 has a hardness of, e.g., 4° (inclusive) to 30° (inclusive) as a hardness based on Asker C. Note that the thermal conductivity of the first electric insulating sheet 27 may also be increased by mixing a large number of fine ceramic particles in the first electric insulating sheet 27.

The second electric insulating sheet 28 has the same arrangement as that of the first electric insulating sheet 27. The second electric insulating sheet 28 is installed as it is pressed between the heat storage unit 26 and the second arched portion 25C of the second bus bar 25. The second electric insulating sheet 28 thermally connects the second bus bar 25 and heat storage unit 26.

Next, the function of the battery pack of this embodiment (a method of controlling the temperature of the battery module 12) will be explained with reference to FIGS. 1, 3, 4, and 5. As shown in FIG. 1, the air supply unit 14 supplies air into the case 13, so that cooling air flows inside the case 13. This cooling air mainly cools the surface 16A (the surface on which the heat storage unit 26 is arranged) of the housing 16 of the battery module 12, and a surface 16B opposing the surface 16A.

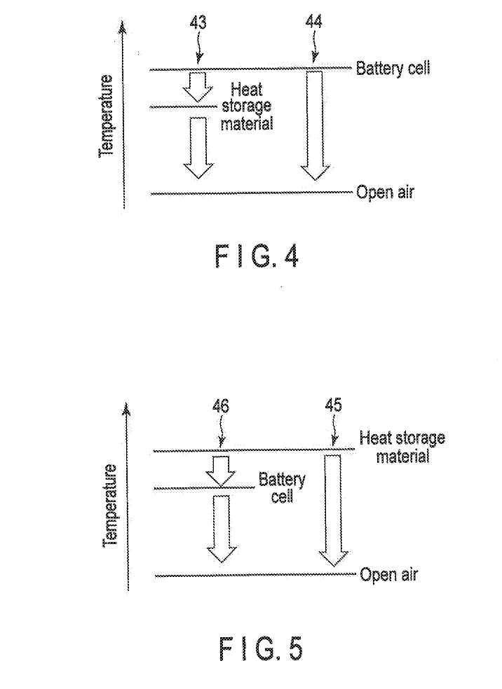

FIG. 4 shows the relationship between the temperature of the battery cells (first to third battery cells 21 to 23) and the temperature of the heat storage material 42 when the battery cells are charged or discharged. As shown in FIG. 4, when charging or discharging starts in the battery cell, a resistance caused by a reaction inside the battery cell and an electrical contact resistance generate heat, and the temperature of the battery cell rises. As shown in FIG. 3, in the first battery cell 21, heat generated in the first cathode 31A and its periphery is transmitted to the first bus bar 24 via the first positive terminal 32A. Similarly, in the second battery cell 22, heat generated in the second anode 33B and its periphery is transmitted to the first bus bar 24 via the second negative terminal 34B. The heat transmitted to the first bus bar 24 is transmitted to the heat storage unit 26 via the first electric insulating sheet 27, and stored in the heat storage unit 26.

In the second battery cell 22, heat generated in the second cathode 33A and its periphery is transmitted to the second bus bar 25 via the second positive terminal 34A. Similarly, in the third battery cell 23, heat generated in the third anode 35B and its periphery is transmitted to the second bus bar 25 via the third negative terminal 36B. The heat transmitted to the second bus bar 25 is transmitted to the heat storage unit 26 via the second electric insulating sheet 28. In this embodiment as described above, when the battery cells (first to third battery cells 21 to 23) are charged or discharged (mainly charged), heat generated from the battery cells is stored in the heat storage unit 26.

As shown in FIG. 3, a part of heat transmitted to the heat storage unit 26 is stored in the heat storage unit 26 (the heat storage material 42), and the other part of the heat is transmitted to the surface 16A of the housing 16 via the adhesive portion 30, and radiated to the cooling air (open air) (see a first heat dissipating path 43 shown in FIG. 4). Also, a part of heat generated in the battery cell is radiated to the cooling air (open air) via the adhesive 29 and the surface 16B of the housing 16 (see a second heat dissipating path 44 shown in FIG. 4).

FIG. 5 shows the relationship between the temperature of the battery cells (first to third battery cells) and the temperature of the heat storage material 42 when charging or discharging is stopped (mainly charging is stopped). When charging or discharging is stopped, heat generation in the battery cell stops. A part of heat stored in the heat storage unit 26 (the heat storage material 42) during charging or discharging is directly transmitted to the surface 16A of the housing 16 via the adhesive portion 30, and radiated to the cooling air (open air) from the surface 16A of the housing 16 (see a third heat dissipating path 45 shown in FIG. 5). Likewise, the other part of the heat stored in the heat storage unit 26 is indirectly transmitted to the surface 16B of the housing 16 via the battery cells (first to third battery cells 21 to 23), and the heat transmitted to the surface 16B of the housing 16 is radiated to the cooling air (open air) (see a fourth heat dissipating path 46 shown in FIG. 5).

When the battery cells (first to third battery cells 21 to 23) are charged or discharged, the heat storage unit 26 containing the heat storage material 42 changes the volume because the heat storage material 42 absorbs heat and fusion progresses. As shown in FIG. 3, however, this embodiment has the structure in which the elastic (flexible) first and second electric insulating sheets 27 and 28 absorb this volume change of the heat storage unit 26. This prevents the deformation of the housing 16 of the battery module 12, and secures the state in which the heat storage unit 26 and the first and second bus bars 24 and 25 are in contact with each other (i.e., the state in which they are thermally connected). Consequently, the heat of the battery module 12 can stably be transmitted to the heat storage unit 26.

In the first embodiment, the battery module 12 includes the first battery cell 21 including the first electrode 31 and the first terminal 32 which continues to the first electrode 31, the second battery cell 22 including the second electrode 33 and the second terminal 34 which continues to the second electrode 33, the bus bar which electrically connects the first and second terminals 32 and 34, the heat storage unit 26 containing the latent heat storage material which absorbs heat when changing from a solid phase to a liquid phase and generates heat when changing from the liquid phase to the solid phase, the elastic electric insulating sheet which is interposed between the bus bar and heat storage unit 26 and thermally connects the bus bar and heat storage unit 26, and the housing 16 accommodating the first battery cell 21, second battery cell 22, bus bar, heat storage unit 26, and the electric insulating sheet.

In this arrangement, the heat storage unit 26 is formed inside the housing 16. Therefore, when compared to a case in which a heat dissipating member such as a heat pipe is formed outside the housing 16, the transport distance until heat generated in the battery cell is absorbed shortens, so the heat storage unit 26 can rapidly absorb heat generated in the battery cell. This makes it possible to suppress a momentary temperature rise (peak temperature) of the battery cell caused by heat generation. In the battery cell, main heat generating sources are normally an electrode where an electric current actually flows and a terminal connected to the electrode. In the above-mentioned arrangement, the heat storage unit 26 absorbs heat via the bus bar electrically connected to the first electrode 31 (the second electrode 33) and the first terminal 32 (the second terminal 34) which continues to the first electrode 31 (the second electrode 33). Therefore, the interior or central portion of the battery cell can efficiently be cooled when compared to a case in which another portion (particularly an outer circumferential portion in contact with an electrolyte) of the first battery cell 21 (the second battery cell 22) is cooled. Furthermore, although the volume changes when the latent heat storage material changes from a solid phase to a liquid phase, the elasticity of the electric insulating sheet can absorb this volume change of the heat storage unit 26. Accordingly, it is possible to maintain the contact state, i.e., the thermally connected state between the bus bar and heat storage unit 26, and reliably transmit heat generated in the first and second battery cells 21 and 22 to the bus bar side.

### Second Embodiment

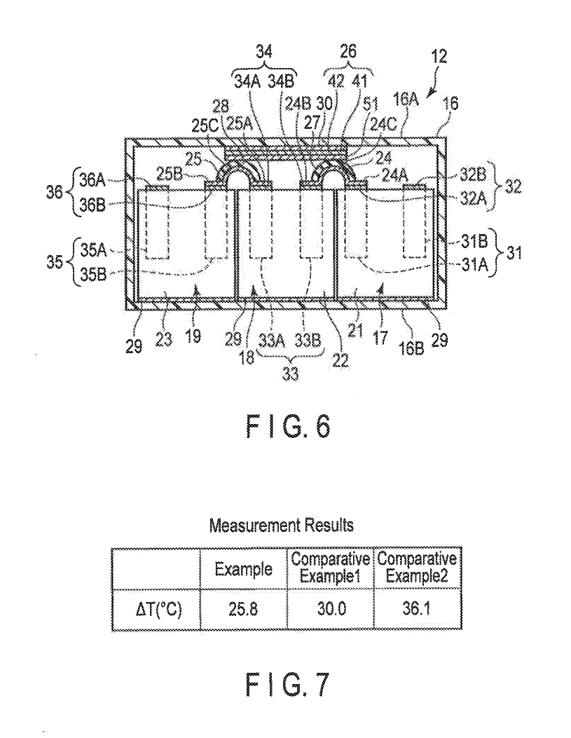

The second embodiment of the battery pack 11 will be explained below with reference to FIG. 6. In this embodiment, the overall structure of the battery pack 11 is the same as that of the first embodiment, but details of the structure of a battery module 12 accommodated in the battery pack 11 differ from those of the first embodiment. Therefore, different portions will mainly be explained, and an explanation of the same portions will be omitted by denoting them with the same reference numerals.

Each battery module 12 includes a housing 16, and first, second, and third battery cell groups 17, 18, and 19 accommodated inside the housing 16. The first battery cell group 17 includes a plurality of first battery cells 21 (as an example, four first battery cells 21). The second battery cell group 18 includes a plurality of second battery cells 22 (as an example, four second battery cells 22). The third battery cell group 19 includes a plurality of third battery cells 23 (as an example, four third battery cells 23).

The battery module 12 includes a plurality of first bus bars 24 (as an example, four first bus bars 24) for electrically connecting a first positive terminal 32A of the first battery cell 21 and a second negative terminal 34B of the second battery cell 22, a plurality of second bus bars 25 (as an example, four second bus bars 25) for electrically connecting a second positive terminal 34A of the second battery cell 22 and a third negative terminal 36B of the third battery cell 23, a heat storage unit 26 adhered to a surface 16A of the housing 16 by an adhesive portion 30, a plurality of first electric insulating sheets 27 (as an example, four first electric insulating sheets 27) formed to cover the first bus bars 24 and interposed between the heat storage unit 26 and first bus bars 24, a plurality of second electric insulating sheets 28 (as an example, four second electric insulating sheets 28) formed to cover the second bus bars 25 and interposed between the heat storage unit 26 and second bus bars 25, a heat diffusing plate 51 interposed between the heat storage unit 26 and first electric insulating sheets 27 (second electric insulating sheets 28), and an adhesive 29 for fixing the first, second, and third battery cells 21, 22, and 23 to the housing 16.

In this embodiment, a heat storage material 42 of the heat storage unit 26 is filled in an aluminum laminated pack as a container case 41. The aluminum laminated pack includes a resin layer and an aluminum layer overlaid on the resin layer. In this embodiment, the heat diffusing plate 51 made of a metal is interposed between the heat storage unit 26 and the first and second electric insulating sheets 27 and 28.

The heat diffusing plate 51 is formed by a metal material such as aluminum or carbon. However, the material of the heat diffusing plate 51 is not limited to aluminum, and may also be any metal material having a high thermal conductivity, such as copper. The heat diffusing plate 51 is adhered to, e.g., a surface of the aluminum laminated pack, which opposes the first and second electric insulating sheets 27 and 28.

In this embodiment, the heat diffusing plate 51 is interposed between the heat storage unit 26 and the first and second electric insulating sheets 27 and 28. Therefore, heat transmitted from the first and second electric insulating sheets 27 and 28 can evenly be diffused in a direction in which the heat diffusing plate 51 extends (a direction perpendicular to the thickness direction of the heat storage unit 26).

In this embodiment, the battery module 12 includes the heat diffusing plate 51 having one surface in contact with one surface of the heat storage unit 26, and the other surface in contact with the electric insulating sheet. In this arrangement, heat transmitted from the electric insulating sheet can evenly be diffused in the direction in which the heat diffusing plate 51 extends. Accordingly, heat does not concentrate at one portion of the heat storage unit 26. This makes it possible to prevent a decrease in cooling efficiency, which is caused by the concentration of heat at one portion of the heat storage unit 26.

### EXAMPLES

Next, a cooling performance measurement test based on the structure of this embodiment will be explained. FIG. 7 shows the results of this measurement test. In this measurement test, the cooling performance of the battery module 12 was evaluated by using an apparatus imitating the battery module 12 of this embodiment.

In the measurement test, an aluminum heater plate containing a heater was used as a heat generating source instead of the battery cell. Four aluminum bus bars (the first bus bars 24) were attached to the upper surface of this heater plate. An electric insulating sheet (the first electric insulating sheet 27) was attached to the surface of an arched portion of the bus bar. The heat storage unit 26 was formed by filling a commercially available sodium acetate hydrate-based latent heat storage material in an aluminum laminated pack including a resin layer and an aluminum layer overlaid on the resin layer. A 1-mm thick aluminum plate (the heat diffusing plate 51) was adhered on a surface of the aluminum laminated pack, which opposed the electric insulating sheet. In this example, the heat storage unit 26 was pressed against the bus bar and electric insulating sheet with a force of 1,500 N.

On the other hand, in Comparative Example 1, the arched portion of the bus bar and the heat storage unit 26 were brought into direct contact with each other by omitting the electric insulating sheet from the arrangement of the above-mentioned example.

In Comparative Example 2, the heat storage unit 26 was omitted from the arrangement of the above-mentioned example. In Comparative Example 2, a 1.0-mm thick aluminum plate (the heat diffusing plate 51) was pressed against the bus bar and the upper surface of the electric insulating sheet with a force of 1,500 N.

In the structure of each of the example and Comparative Examples 1 and 2, a constant input of 100 W was applied to the heater plate at an environmental temperature of 25° C., and the temperature rise amount of the heater plate was measured. FIG. 7 shows the comparison results of the heater plate temperature rise amounts (ΔT (° C.)) when 40 minutes elapsed after the start of the measurements. The results shown in FIG. 7 reveal that the arrangement of the example was able to suppress the heater plate temperature rise compared to Comparative Examples 1 and 2.

### Third Embodiment

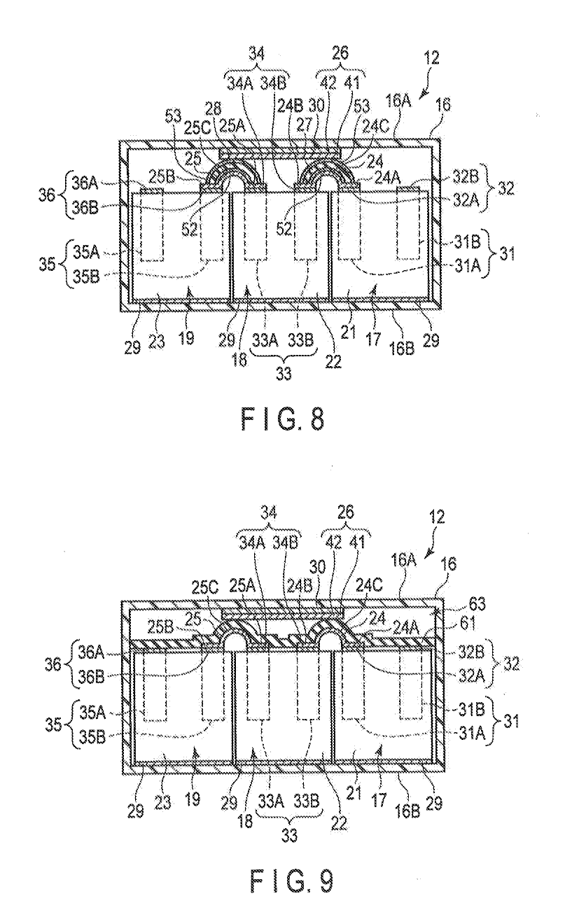

The third embodiment of the battery pack 11 will be explained below with reference to FIG. 8. In this embodiment, the differences of the battery pack 11 from the first embodiment are in the details of the structure of a battery module 12, and the rest is the same as the first embodiment. Therefore, different portions will mainly be explained, and an explanation of the same portions will be omitted by denoting them with the same reference numerals.

As shown in FIG. 8, the battery module 12 includes a housing 16, and first, second, and third battery cell groups 17, 18, and 19 accommodated inside the housing 16. The first battery cell group 17 includes a plurality of first battery cells 21 (as an example, four first battery cells 21). The second battery cell group 18 includes a plurality of second battery cells 22 (as an example, four second battery cells 22). The third battery cell group 19 includes a plurality of third battery cells 23 (as an example, four third battery cells 23).

The battery module 12 includes a plurality of first bus bars 24 (as an example, four first bus bars 24) for electrically connecting a first positive terminal 32A of the first battery cell 21 and a second negative terminal 34B of the second battery cell 22, a plurality of second bus bars 25 (as an example, four second bus bars 25) for electrically connecting a second positive terminal 34A of the second battery cell 22 and a third negative terminal 36B of the third battery cell 23, a heat storage unit 26 adhered to one surface of the housing 16 by an adhesive portion 30, a plurality of first electric insulating sheets 27 (as an example, four first electric insulating sheets 27) formed to cover the first bus bars 24 and interposed between the heat storage unit 26 and first bus bars 24, a plurality of second electric insulating sheets 28 (as an example, four second electric insulating sheets 28) formed to cover the second bus bars 25 and interposed between the heat storage unit 26 and second bus bars 25, and an adhesive 29 for fixing the first, second, and third battery cells 21, 22, and 23 to the housing 16.

The battery module 12 includes a first adhesive layer 52 interposed between the first bus bar 24 and first electric insulating sheet 27, and a second adhesive layer 53 interposed between the first electric insulating sheet 27 and heat storage unit 26. The first adhesive layer 52 adheres the first bus bar 24 and first electric insulating sheet 27. The first adhesive layer 52 increases the adhesion of the first electric insulating sheet 27 to the first bus bar 24. The second adhesive layer 53 adheres the first electric insulating sheet 27 and heat storage unit 26.

Similarly, the battery module 12 includes a first adhesive layer 52 interposed between the second bus bar 25 and second electric insulating sheet 28, and a second adhesive layer 53 interposed between the second electric insulating sheet 28 and heat storage unit 26. The first adhesive layer 52 adheres the second bus bar 25 and second electric insulating sheet 28. The first adhesive layer 52 increases the adhesion of the second electric insulating sheet 28 to the second bus bar 25. The second adhesive layer 53 adheres the second electric insulating sheet 28 and heat storage unit 26. The first and second adhesive layers 52 and 53 are made of, e.g., an acrylic-based adhesive.

In this embodiment, the battery module 12 includes the first adhesive layer 52 which is interposed between the bus bar and electric insulating sheet and adheres the bus bar and electric insulating sheet, and the second adhesive layer 53 which is interposed between the electric insulating sheet and heat storage unit 26 and adheres the electric insulating sheet and heat storage unit 26.

In this arrangement, it is possible to prevent the removal of the electric insulating sheet from the position between the bus bar and heat storage unit 26 due to an external shock or vibration. This can improve the shock resistance and reliability of the battery module 12.

### Fourth Embodiment

The fourth embodiment of the battery pack will be explained below with reference to FIG. 9. In this embodiment, the differences of the battery pack 11 from the first embodiment are in the details of the structure of a battery module 12, and the rest is the same as the first embodiment. Therefore, different portions will mainly be explained, and an explanation of the same portions will be omitted by denoting them with the same reference numerals.

The battery module 12 includes a housing 16, and first, second, and third battery cell groups 17, 18, and 19 accommodated inside the housing 16. The first battery cell group 17 includes a plurality of first battery cells 21 (as an example, four first battery cells 21). The second battery cell group 18 includes a plurality of second battery cells 22 (as an example, four second battery cells 22). The third battery cell group 19 includes a plurality of third battery cells 23 (as an example, four third battery cells 23).

The battery module 12 includes a plurality of first bus bars 24 (as an example, four first bus bars 24) for electrically connecting a first positive terminal 32A of the first battery cell 21 and a second negative terminal 34B of the second battery cell 22, a plurality of second bus bars 25 (as an example, four second bus bars 25) for electrically connecting a second positive terminal 34A of the second battery cell 22 and a third negative terminal 36B of the third battery cell 23, a heat storage unit 26 adhered to a surface 16A of the housing 16 by an adhesive portion 30, an electric insulating sheet 61 formed to cover the first bus bars 24 and second bus bars 25, and an adhesive 29 for fixing the first, second, and third battery cells 21, 22, and 23 to the housing 16.

In this embodiment, the electric insulating sheet 61 is formed by integrating the first and second electric insulating sheets 27 and 28 of the first embodiment. That is, the electric insulating sheet 61 is interposed between the first bus bar 24 and heat storage unit 26 and between the second bus bar 25 and heat storage unit 26. The electric insulating sheet 61 partitions the interior of the housing 16 into a first space 62 in which the first and second battery cells 21 and 22 are formed, and a second space 63 in which the heat storage unit 26 is formed. The electric insulating sheet 61 fluidly isolates the first and second spaces 62 and 63.

The electric insulating sheet 61 is formed by a rubber-like elastic (flexible) sheet. The electric insulating sheet 61 is installed as it is pressed between the heat storage unit 26 and a first arched portion 24C of the first bus bar 24, and between the heat storage unit 26 and a second arched portion 25C of the second bus bar 25. The electric insulating sheet 61 has electric insulation which withstands the voltage of each battery cell. More specifically, the electric insulating sheet 61 has a dielectric breakdown strength of 1 kV/mm or more as a dielectric breakdown strength complying with JIS-C2110. The electric insulating sheet 61 is formed by, e.g., a rubber sheet, but the material of the electric insulating sheet 61 is not limited to this. The electric insulating sheet 61 may also be a low-hardness acrylic sheet or foamed sheet. The electric insulating sheet 61 has a hardness of, e.g., 4° (inclusive) to 30° (inclusive) as a hardness based on Asker C. Note that the thermal conductivity of the electric insulating sheet 61 may also be increased by mixing a large number of fine ceramic particles in the electric insulating sheet 61.

In this embodiment, the electric insulating sheet 61 partitions the interior of the housing 16 into the first space 62 in which the first and second battery cells 21 and 22 are formed, and the second space 63 in which the heat storage unit 26 is formed. Generally, many latent heat storage materials (e.g., a sodium sulfate hydrate-based latent heat storage material and sodium acetate hydrate-based heat storage material) are conductive, so a shortcircuit may occur if the latent heat storage material leaks out and adheres to the terminal of the battery cell. In the above-mentioned arrangement, however, even if the latent heat storage material in the heat storage unit 26 leaks out into the housing 16, it is possible to prevent the latent heat storage material from entering the first space 62. This can improve the reliability and safety of the battery pack 11.

The battery pack 11 of each of the above-mentioned embodiments is of course usable as, e.g., a battery pack to be used in automobiles such as an electric vehicle and hybrid vehicle, motorbikes, rolling stocks, airplanes, linear motor cars, ships, and other conveyances, a battery pack to be used in apparatuses fixedly installed on the ground, and a battery pack to be used in various electric apparatuses. It is also possible to carry out the first, second, third, and fourth embodiments by combining them. When combining the third and fourth embodiments, the first adhesive layer 52 improves the adhesion of the electric insulating sheet 61 to the first bus bars 24, the second bus bars 25, and the first to third battery cells 21 to 23.

Furthermore, each embodiment adopts the arrangement in which heat stored in the heat storage unit 26 when charging (or discharging) is performed is gradually cooled when no charging (or no discharging) is performed. However, it is also possible to use an overcooling latent heat storage material as the heat storage material 42, and instantaneously radiate heat stored in the heat storage material 42 to the open air by using nucleation when no charging (or no discharging) is performed. In this case, a controller for controlling the nucleation is configured by an electronic circuit including an integrated circuit, and installed outside the battery pack 11 (e.g., in a controller of a vehicle when the battery pack 11 is installed in the vehicle).

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A battery module comprising:
battery cells, each including an electrode group including an anode, a cathode, and a separator interposed between the anode and the cathode, a terminal electrically connected to the electrode group, and a packaging member which contains the electrode group and through which the terminal is extracted outside from inside;
a bus bar configured to electrically connect the terminals of the battery cells;
a heat storage unit containing a latent heat storage material; and
an electric insulating sheet configured to thermally connect the bus bar and the heat storage unit.

2. The module according to claim 1, wherein the electric insulating sheet has elasticity.

3. The module according to claim 1, further comprising a housing which contains the battery cells, the heat storage unit and the electric insulating sheet.

4. The module according to claim 1, further comprising a heat diffusing plate made of a metal and interposed between the heat storage unit and the electric insulating sheet.

5. The module according to claim 3, wherein the electric insulating sheet partitions an interior of the housing into a first space in which the plurality of battery cells are formed, and a second space in which the heat storage unit is formed.

6. The module according to claim 1, wherein the electric insulating sheet has a hardness of 4° (inclusive) to 30° (inclusive) as an Asker C hardness.

7. The module according to claim 1, wherein a surface of the heat storage unit, which is opposite to a surface facing the bus bar, is in contact with the housing.

8. A temperature control method of a battery module comprising
battery cells, each including an electrode group including an anode, a cathode, and a separator interposed between the anode and the cathode, a terminal electrically connected to the electrode group, and a packaging member which contains the electrode group and through which the terminal is extracted outside from inside,
a bus bar configured to electrically connect the terminals of the battery cells,
a heat storage unit containing a latent heat storage material,
an electric insulating sheet configured to thermally connect the bus bar and the heat storage unit, and
a housing accommodating the plurality of battery cells, the heat storage unit, and the electric insulating sheet,
the method comprising:
storing heat generated from the plurality of battery cells in the heat storage unit when the battery cells are charged; and
when no charging is performed, directly transmitting the heat stored in the heat storage unit to the housing, and indirectly transmitting the heat stored in the heat storage unit to the housing via the battery cells, thereby radiating the heat to an outside via the housing by feeding air to the outer surface of the housing.
